(19) United States
(12) Patent Application Publication
(10) Pub. No.: US 2006/0176919 A1
(43) Pub. Date: Aug. 10, 2006

(54) Method for driving laser element, driving circuit for laser element, optical communications apparatus, electronic device

(76) Inventors: Kimio Nagasaka, Suwa-shi (JP); Atsushi Harada, Suwa-shi (JP)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/284,671

(22) Filed: Nov. 22, 2005

(30) Foreign Application Priority Data
Feb. 4, 2005 (JP) 2005-029350

(51) Int. Cl. H01S 3/00

(52) U.S. Cl. 372/38.02

(57) ABSTRACT

A driving method for making a laser element to emit light by supplying a predetermined drive current to the laser element includes supplying a preliminary current smaller than the drive current immediately before supplying the drive current to the laser element, wherein substantially no current is supplied to the laser element other than a period in which the preliminary current or the drive current is supplied.

The entire disclosure of Japanese Patent Application No. 2005-029350, filed Feb. 4, 2005 is expressly incorporated by reference herein.

### BACKGROUND

1. Technical Field

The present invention relates to technologies for driving laser elements used in apparatuses for performing data communications that use light.

2. Related Art

Recently, studies are being conducted for mounting optical communications modules on small-size portable apparatuses such as notebook type personal computers, cellular phones and the like. When an optical communications module is mounted on a portable apparatus, the consumption of power necessary for driving an optical device such as a laser element is required to be made as small as possible. In response to such requirements, JP-A-8-23310 and JP-A-2004-153442 propose methods for transmitting optical signals in which the time (pulse width) for a laser element to emit light is shortened, and information is expressed by the length of an interval between one emission pulse and the next emission pulse, to reduce the power required for driving the laser element.

According to the methods described above, an optical pulse is generated by rapidly supplying a drive current to the laser element in a state where no current is applied to the laser element, such that the light emission timing (rise timing) of the laser element would likely fluctuate randomly. Such fluctuation in the emission timing causes problems such as increased jitters in signal transmission and lowered transmission quality. In contrast, it may be possible to use a method in which a drive current in a magnitude of about the threshold current of a laser element is always supplied even when the laser element is not operated for emission. However, this method is not preferable because the power is steadily consumed, and the power consumption cannot be reduced very much.

### SUMMARY

In accordance with an advantage of some aspects of the invention, there is provided a technology that reduces the power consumption and improve the quality in data transmission.

A first embodiment of the invention pertains to a driving method for driving a laser element to emit light by supplying a predetermined drive current to the laser element. In accordance with an aspect of the first embodiment, the driving method includes supplying a preliminary current smaller than the drive current immediately before supplying the drive current to the laser element, wherein substantially no current is supplied to the laser element other than a period in which the preliminary current or the drive current is supplied.

A second embodiment of the invention pertains to a driving method for driving a laser element to emit light by supplying a predetermined drive current to the laser element. In accordance with an aspect of the second embodiment, the driving method includes a first stage of supplying a preliminary current smaller than the drive current to the laser element during a period from a time when a timing to drive the laser element to emit light came until a time t1 elapses, and a second stage of supplying the drive current to the laser element from a time when the time t1 elapsed until a time t2 elapses, wherein substantially no current is supplied to the laser element other than the period in which the preliminary current or the drive current is supplied.

According to the driving methods in accordance with the embodiments described above, the preliminary current is supplied immediately before supplying the drive current for driving the laser element to emit light, whereby the timing of light emission of the laser element can be prevented from becoming fluctuated, and therefore generation of jitters can be avoided. Also, the preliminary current is supplied only during a period when the laser element is to be driven to emit light, and is not supplied other than the aforementioned period, such that steady power consumption does not take place. Accordingly, when the laser element is driven, a reduction of power consumption and an improvement in transmission quality can both be achieved.

The preliminary current described above may preferably be in a magnitude generally equal to a threshold current of the laser element.

Consequently, the light emission timing can be further stabilized.

Also, the second stage may preferably be such that a timing of rising or falling of a pulse signal superimposed with digital data concurs with the timing to drive the laser element to emit light.

Consequently, the laser element is driven to emit light only at a point where the pulse signal changes, such that the power consumption can be further controlled.

A third embodiment of the invention pertains to a driving circuit for driving a laser element to emit light by supplying a predetermined drive current to the laser element. The driving circuit is equipped an edge detector that receives an input of a pulse signal superimposed with digital data, detects rising and falling edges of the pulse signal and generates a predetermined detection signal, a timing generator that outputs a first timing signal during a period from a time when the detection signal was outputted from the edge detector until at least a time t1 elapses, and outputs a second timing signal during a period from the time when the time t1 elapsed after the detection signal was outputted from the edge detector until a time t2 elapses, and a current control circuit that supplies a preliminary current smaller than the drive current to the laser element while the timing generator is outputting the first timing signal, supplies the drive current to the laser element while the timing generator is outputting the second timing signal, and places the laser element in a state in which no current is supplied to the laser element when the first timing signal or the second timing signal is not outputted.

According to the driving circuit in accordance with the third embodiment, the preliminary current is supplied immediately before supplying the drive current for driving the laser element to emit light, whereby the timing of light emission of the laser element can be prevented from becoming fluctuated, and therefore generation of jitters can be avoided. Also, the preliminary current is supplied only during a period when the laser element is made to emit light, and is not supplied other than the aforementioned period, such that steady power consumption does not take place. Accordingly, when the laser element is driven, a reduction of power consumption and an improvement in transmission quality can both be achieved.

The timing generator may preferably output the first timing signal during a period from the time when the detection signal was outputted until a total time of the time t1 and the time t2 elapses, and the current control circuit may preferably supply the preliminary current to the laser element while the first timing signal is being outputted, and generate an additional current and supply a mixed current of the additional current and the preliminary current to the laser element while the second timing signal is being outputted.

By this, the preliminary current and the drive current can be readily generated.

Also, the preliminary current described above may preferably be in a magnitude generally equal to a threshold current of the laser element.

By this, the light emission timing can be more stabilized.

A fourth embodiment of the invention pertains to an optical module equipped with the above-described driving circuit for driving a laser element. Such an optical module can be mounted on a variety of electronic devices, such as, for example, a personal computer, a cellular phone, a so-called PDA (portable data terminal apparatus) and the like, and can be used for data communications with an external device or the like by using light as a transmission medium.

By this, a communications device that operates with low power consumption and is excellent in communication quality can be constructed.

A fifth embodiment of the invention pertains to an electronic device equipped with the optical module described above. It is noted here that the “electronic device” refers to any device in general that realizes a specified function by using an electric circuit or the like, and is not particularly limited to any specific structure. As the electronic devices, various types of devices, such as, for example, personal computers, PDAs (portable data assistants), electronic notebooks, and the like can be enumerated.

By using the optical module in accordance with the invention, an electronic device can be operated with lower power consumption and can improve the communication quality.

### BRIEF DESCRIPTION OF THE DRAWINGS

FIG. 1 is a circuit diagram for describing a structure of a laser element driving circuit in accordance with an embodiment of the invention.

FIGS. 2A-2D are waveform diagrams for describing operation details of the laser element driving circuit.

FIG. 3 is a diagram for describing in greater detail currents to be supplied to the laser element.

FIGS. 4A and 4B are diagrams for describing details of a method for generating a preliminary current or a drive current.

FIGS. 5A and 5B are diagrams for describing in detail another example of a method for generating a preliminary current or a drive current.

FIG. 6 is a block diagram for describing an example of a structure of an optical module.

FIG. 7 is a perspective view of a structure of an example of an electronic device.

### DESCRIPTION OF EXEMPLARY EMBODIMENTS

Preferred embodiments of the invention are described below with reference to the accompanying drawings.

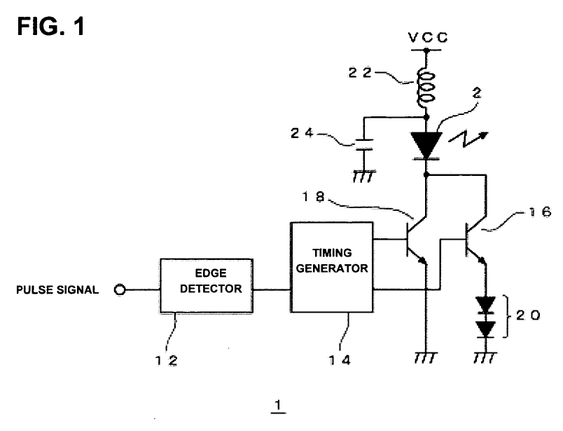

FIG. 1 is a circuit diagram for describing a structure of a laser element driving circuit in accordance with an embodiment of the invention. A laser element driving circuit 1 supplies a predetermined drive current to a laser element 2 to drive the laser element 2 to emit light, and includes an edge detector 12, a timing generator 14, transistors 16 and 18, a diode 20, a coil 22, and a capacitor 24. It is noted here that the laser element 2 is an element that emits light as a predetermined drive current is applied, such as, for example, an edge emission type or surface emission type semiconductor laser. In the laser element driving circuit 1 of the present embodiment, the laser element 2 has one electrode connected to a power supply (VCC) side and another electrode connected to a current control circuit formed with the transistors 16 and 18.

A pulse signal superimposed with digital data is inputted in the edge detector 12, and the edge detector 12 detects rising edges and falling edges of the pulse signal, and generates a corresponding detection signal. The detection signal generated by the edge detector 12 is inputted in the timing generator 14.

When the detection signal is inputted from the edge detector 12, the timing generator 14 outputs a first timing signal at least until a time t1 elapses. Also, the timing generator 14 outputs a second timing signal until a time t2 elapses after the time t1 elapsed after the detection signal was outputted from the edge detector 12.

The transistor 16 has a collector terminal that is connected to the other electrode of the laser element 2, an emitter terminal connected to grounding (GND) through the diode 20, and a base terminal connected to the timing generator 14. The first timing signal generated by the timing generator 14 is inputted in the base terminal of the transistor 16. Similarly, the transistor 18 has a collector terminal connected to the other electrode of the laser element 2, an emitter terminal connected to grounding (GND), and a base terminal connected to the timing generator 14. The second timing signal generated by the timing generator 14 is inputted in the base terminal of the transistor 18.

The current control circuit that controls the current to be supplied to the laser element 2 is formed with these transistors 16 and 18. More concretely, the current control circuit including these transistors 16 and 18 supplies to the laser element 2 a preliminary current that is smaller than a drive current while the first timing signal is being outputted from the timing generator 14, supplies to the laser element 2 the drive current while the second timing signal is being outputted from the timing generator 14, and sets a condition in which no current is supplied to the laser element 2 when neither the first timing signal or the second timing signal is being outputted. Details of the current control are described below.

The diode 20 is connected between the emitter terminal of the transistor 16 and grounding, and has a current adjusting function.

The coil 22 is connected between the power supply and the one electrode of the laser element 2. The capacitor 24 has one end connected to the one electrode of the laser element 2 and another end connected to grounding. The coil 22 and the capacitor 24 mutually co-operate to thereby function like a low-pass filter to stabilize the voltage to be applied to the laser element 2.

The laser element driving circuit 1 in accordance with the present embodiment has the structure described above, and operates according to the details described below.

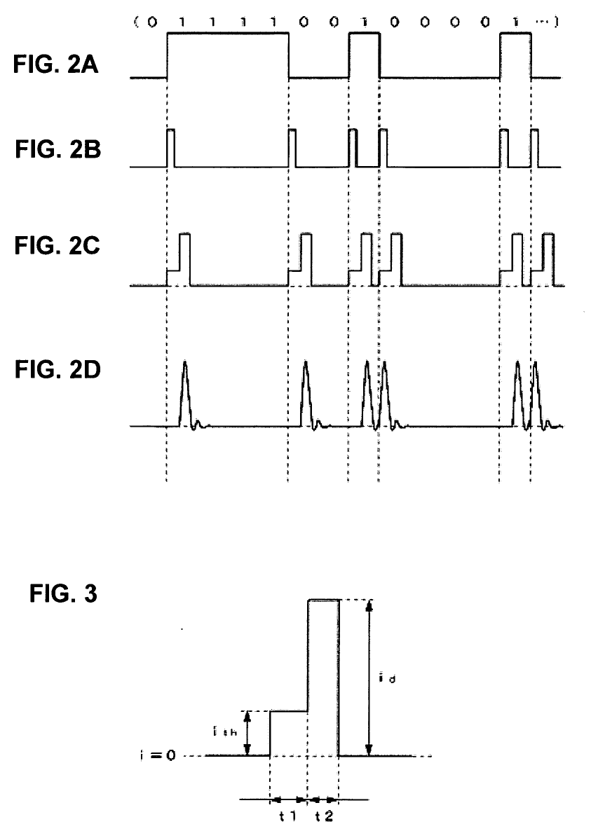

FIGS. 2A-2D are waveform diagrams for describing operations of the laser element driving circuit 1.

FIG. 2A shows an example of a pulse signal superimposed with a digital signal. In the present embodiment, an NRZ (non return to zero) signal shown in FIG. 2A is explained as an example of the input signal. More specifically, the illustrated pulse signal is coded in a manner that data “1” corresponds to a signal level at H level and data “0” corresponds to a signal level at L level, and the signal level does not return to L level even when multiple data “1” continues. In other words, the pulse signal in accordance with the present embodiment expresses digital information by the duration (clock number) of H level or L level. It is noted that a series of numbers indicated at the upper side of the waveform diagram of FIG. 2A expresses contents (“0” or “1”) of the digital signal superimposed with the pulse signal. The laser element driving circuit 1 in accordance with the present embodiment operates in response to the pulse signal in a manner that the laser element 2 emits light according to changing points (rising or falling) of the pulse signal.

FIG. 2B shows an example of the detection signal that is generated by the edge detector 12. As shown in the diagram, rising edges and falling edges of the pulse signal are detected by the edge detector 12, whereby a corresponding detection signal is generated.

FIG. 2C shows an example of currents that are supplied to the laser element 2. As shown in the diagram, the laser element driving circuit 1 in accordance with the present embodiment supplies drive currents to the laser element 2 in synchronism with the detection signal (see FIG. 2B). In this instance, as shown in FIG. 2C, immediately before supplying to the laser element 2 a drive current i_{d} that is in a magnitude necessary for emission, the laser element driving circuit 1 supplies a preliminary current iₜₕ that is smaller than the drive current i_{d} for a predetermined period of time. Also, as shown in FIG. 2C, the laser element driving circuit 1 supplies substantially no current to the laser element 2 other than the periods of supplying the preliminary current iₜₕ or the drive current i_{d}.

FIG. 2D shows an example of an emission state (emission intensity) of the laser element 2 when the currents shown in FIG. 2C are supplied. As shown in FIG. 2D, the laser element 2 does not emit light during a period when the preliminary current iₜₕ smaller than the drive current i_{d} (in other words, in a magnitude insufficient to cause emission of light) is supplied, and then, as the drive current i_{d} is supplied, the laser element 2 emits light in a pulse shape.

FIG. 3 is a diagram for describing currents to be supplied to the laser element 2 in greater detail.

As shown in FIG. 3, the laser element driving circuit 1 supplies the preliminary current iₜₕ to the laser element 2 during a period from a time when a timing to drive the laser element 2 to emit light comes until a time t1 elapses (first stage). It is noted here that the “timing to drive the laser element 2 to emit light” may be set in association with changing points of the pulse signal shown in FIG. 2A, and is set, in accordance with the present embodiment, in synchronism with rise and fall timings of the pulse signal. Also, the preliminary current iₜₕ is acceptable as long as it has a sufficient magnitude to stabilize the emission timing of the laser element 2, and more concretely it is desirable if it has a magnitude generally equal to a threshold current of the laser element 2. Also, the time t1 to supply the preliminary current iₜₕ to the laser element 2 is set to a sufficient duration (time width) necessary to stabilize the emission timing of the laser element.

Also, as shown in FIG. 3, the laser element driving circuit 1 supplies the drive current i_{d} to the laser element 2 during a period from a time when the time t1 to supply the preliminary current iₜₕ elapsed until a time t2 elapses (second stage). It is noted here that the drive current i_{d} is set to a sufficient magnitude necessary to cause the laser element 2 to emit light with light energy necessary for optical transmission (in other words, detectable by a receiving side), and is supplied to the laser element 2 for a necessary and sufficient time t2.

Also, as shown in FIG. 3, the laser element driving circuit 1 does not supply a current to the laser element 2 other than the periods of supplying the preliminary current iₜₕ or the drive current i_{d}.

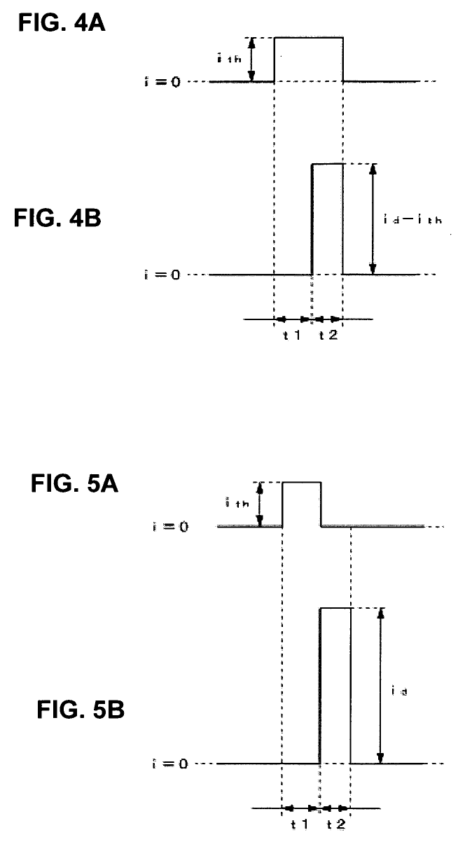

FIGS. 4A and 4B are diagrams for describing details of a method for generating the preliminary current iₜₕ or the drive current i_{d} in the laser element driving circuit 1.

As described above, when the detection signal is outputted from the edge detector 12, the first timing signal is outputted from the timing generator 14, and inputted in the transistor 16. As described above, the first timing signal may be sufficient if it is outputted for at least the duration of time t1, but the first timing signal in the present embodiment is outputted for a time duration of (t1+t2). In this instance, only the transistor 16 among the transistors 16 and 18 is turned on, and a current flows only in a current path including the transistor 16, whereby the preliminary current iₜₕ is supplied to the laser element 2, as shown in FIG. 4A. The magnitude of the preliminary current iₜₕ is adjusted by setting the falling voltage in a forward direction of the diode 20 to an appropriate value.

After the time t1 has elapsed, the second timing signal is outputted from the timing generator 14, and inputted in the transistor 18. As described above, the second timing signal is outputted for a time t2. As described above, the first timing signal is continuously being outputted, such that both of the transistors 16 and 18 turn on. In this instance, the circuit is set such that an additional current (i_{d}-iₜₕ) in a magnitude corresponding to at least a difference between the drive current and the preliminary current flows in a current path including the transistor 18. By this, the sum of the currents flowing in the respective current paths is supplied to the laser element 2. In other words, during the time t2 while the second timing signal is being outputted, the drive current i_{d} is supplied to the laser element 2.

FIGS. 5A and 5B are diagrams for describing details of another example of a method for generating the preliminary current iₜₕ or the drive current i_{d} in the laser element driving circuit 1.

In the present example, the period in which the first timing signal is outputted from the timing generator 14 is set to a time t1. In this instance, the transistor 16 turns on only during the time t1 while the first timing signal is being outputted, and the preliminary current iₜₕ is supplied to the laser element 2 during this period (see FIG. 5A).

After the time t1 has elapsed, the second timing signal is outputted from the timing generator 14, and the transistor 18 is turned on. As the first timing signal is not outputted, the transistor 16 turns off, and no current flows in a current path including the transistor 16. By this, only a current that flows in a current path including the transistor 18 is supplied to the laser element 2. In this instance, by setting the circuit such that a current in a magnitude equivalent to the drive current i_{d} flows in the current path including the transistor 18, the drive current i_{d} is supplied to the laser element 2 during the time t2 while the second timing signal is being outputted.

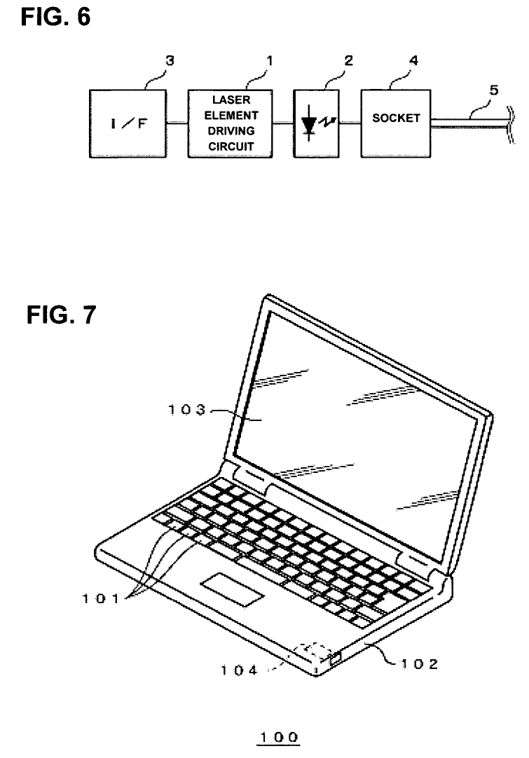

FIG. 6 is a block diagram for describing a structural example of an optical module that includes the laser element driving circuit 1 described above. The optical module shown in FIG. 6 includes the laser element driving circuit 1 in accordance with the present embodiment described above, a laser element 2 driven by the laser element driving circuit 1, an interface (I/F) 3 for transmitting and receiving communication data between a host apparatus (such as, for example, a personal computer or the like) and the laser element driving circuit 1, and a socket 4 for optically connecting an optical transmission medium 5 such as an optical fiber or the like and the laser element 2.

FIG. 7 is a perspective view showing the composition of a personal computer, which is an example of an electronic apparatus, equipped with an optical module in accordance with the present embodiment or an optical communications device formed with the optical module. The notebook type (thin) personal computer 100 shown in FIG. 7 is equipped with a main body section 102 having a keyboard 101, a display panel 103, and an optical module 104. The optical module 104 is equipped with the structure shown in FIG. 6 described above, mounted inside the main body section 102 of the personal computer 100, and used for conducting mutual data communications between the personal computer 100 and an external device.

According to the present embodiment, the preliminary current iₜₕ is supplied immediately before supplying the drive current i_{d} for driving the laser element 2 to emit light, whereby the light emission timing can be prevented from becoming fluctuated, and therefore generation of jitters can be avoided. Also, the preliminary current iₜₕ is supplied only during a period when the laser element 2 is made to emit light, and is not supplied other than the aforementioned period, such that steady power consumption does not take place. Accordingly, when the laser element 2 is driven, a reduction of power consumption and an improvement in transmission quality can both be achieved.

It is noted that the invention is not limited to the contents of the embodiments described above, and a variety of changes can be made within the scope of the subject matter of the invention.

What is claimed is:

1. A driving method for making a laser element to emit light by supplying a predetermined drive current to the laser element, the driving method comprising:
supplying a preliminary current smaller than the drive current immediately before supplying the drive current to the laser element, wherein substantially no current is supplied to the laser element other than a period in which the preliminary current or the drive current is supplied.

2. A driving method for making a laser element to emit light by supplying a predetermined drive current to the laser element, the driving method comprising:
a first stage of supplying a preliminary current smaller than the drive current to the laser element during a period from a time when a timing to make the laser element to emit light came until a time t1 elapses; and
a second stage of supplying the drive current to the laser element during a period from a time when the time t1 elapsed until a time t2 elapses,
wherein substantially no current is supplied to the laser element other than the period in which the preliminary current or the drive current is supplied.

3. A driving method according to claim 2, wherein the preliminary current is in a magnitude generally equal to a threshold current of the laser element.

4. A driving method according to claim 2, wherein, in the second stage, a rising or falling timing of a pulse signal superimposed with digital data concurs with the timing to make the laser element to emit light.

5. A driving circuit for driving a laser element to emit light by supplying a predetermined drive current to the laser element, the driving circuit comprising:
an edge detector that receives an input of a pulse signal superimposed with digital data, detects rising and falling edges of the pulse signal and generates a corresponding detection signal;
a timing generator that outputs a first timing signal during a period from a time when the detection signal is outputted from the edge detector until at least a time t1 elapses, and outputs a second timing signal during a period from the time when the time t1 elapsed after the detection signal was outputted from the edge detector until a time t2 elapses; and
a current control circuit that supplies a preliminary current smaller than the drive current to the laser element while the timing generator is outputting the first timing signal, supplies the drive current to the laser element while the timing generator is outputting the second timing signal, and places the laser element in a state in which no current is supplied to the laser element when the first timing signal or the second timing signal is not outputted.

6. A driving circuit according to claim 5, wherein the timing generator outputs the first timing signal during a period from a time when the detection signal was outputted until a total time of the time t1 and the time t2 elapses, and
the current control circuit supplies the preliminary current to the laser element while the first timing signal is being outputted, and generates an additional current and supplies a mixed current of the additional current and the preliminary current as the drive current to the laser element while the second timing signal is being outputted.

7. A driving circuit according to claim 5, wherein the preliminary current is in a magnitude generally equal to a threshold current of the laser element.

8. An optical module equipped with the driving circuit recited in claim 5.

9. An electronic device equipped with the optical module according to claim 8.
